(19) United States
(12) Patent Application Publication
(10) Pub. No.: US 2002/0101073 A1
(43) Pub. Date: Aug. 1, 2002

(54) Aviation checklist and method of advertising which incorporates an aviation checklist

(76) Inventor: D. Rich Lang, Atlanta, GA (US)

Correspondence Address: ROBERT R. WATERS, ESQ., WATERS LAW OFFICE, PLLC, 633 SEVENTH STREET, HUNTINGTON, WV, 25701, US

(21) Appl. No.: 09/773,343

(22) Filed: Jan. 31, 2001

(51) Int. Cl. G09F 1/00

(52) U.S. Cl. 283/56

(57) ABSTRACT

A method of advertising is disclosed whereby an advertising message is incorporated into an aviation checklist in order to provide a means for commercial advertisers to target market products and services to pilots and other flight personnel of an aircraft. As the aviation checklist is used and re-used in every flight, the advertisement message, which is permanently incorporated into the checklist article, is reinforced. An advertisement article produced pursuant to the method is also claimed and may take a variety of constructions and forms, as disclosed and claimed.

### STATEMENT REGARDING FEDERALLY SPONSORED RESEARCH OR DEVELOPMENT

Not Applicable

### REFERENCE TO A MICROFICHE APPENDIX

Not Available

### BACKGROUND OF THE INVENTION

This invention relates generally to aviation checklists for private and commercial aircraft. More specifically, this invention relates to a direct method of advertising utilizing an aviation checklist in order to specifically direct the advertising message to the operator of the aircraft.

In the United States, millions of dollars are spent each day on advertising. Advertising takes a wide variety of forms and permeates essentially all aspects of American life. Advertising displays can be found on billboards, taxi cabs, newspapers, and advertising messages are constantly beamed at consumers via radio, television, and more recently, the Internet. In view of the wide assortment of advertising media and the enormous dimension of the messages being sent to consumers, it is easy to surmise that advertising overload may be a problem. When consumers receive too many messages from too many sources, they easily learn to disregard all of them, or even subconsciously begin to do so. For the advertiser, it therefore becomes a more important challenge to specifically target its advertising dollars to reach the specific consumers who are most likely to be receptive to the message.

Another common feature of most printed advertisement media is the disposable nature of the article. Each day, we all see advertisements in newspapers as well as flyers, wrappers, and magazines. Quite frequently, the consumer will quickly skim the advertisement if they read it at all, and discard the paper article in the closest trash receptacle he or she can find. Accordingly, many advertising dollars are wasted, and the advertiser must compensate for this dilemma by printing and distributing even more of such articles such that the percentage of receptive viewers rises to an acceptable level. Of course, the waste of natural resources and disposal cost of unwanted advertising articles is also a consequent social cost for all of us to bear.

A preferred alternative for the advertiser is to place the advertisement on an article which the consumer will not want to throw away. This is specifically the case with reference material. For example, advertisements on the back of telephone directories are particularly effective because the consumer needs to retain the telephone directory and will make certain it is not discarded. In addition, each time the consumer reaches for the telephone book, his perception is often first captured by the advertisement on the back of the book. By receiving the same message over and over again, it is reinforced. Advertising on a multiple-use reference article is both more effective and less wasteful; accordingly, the advertising value is much greater.

Another problem facing commercial advertisers is the desire to target specific consumer demographics with the advertisement medium. For example, the marketer of high-end automobiles or sports cars will seek to aim advertisements at consumers with higher disposable incomes and accordingly, advertisements for luxury items are placed in magazines or other publications that are frequented by consumers of that demographic category. Therefore, an advertiser who wishes to reach consumers with high disposable incomes should specifically direct advertisements to an article to be viewed by those people, and for maximum efficiency, the advertisement should be placed on an article which the consumer must use repetitively and not throw away.

One market demographic that is particularly attractive to many advertisers is owners of private or commercial aircrafts, and commercial aircraft pilots. Individuals who purchase and operate aircrafts as well as commercial airline pilots tend to have high incomes and an above average spending lifestyle. In addition, since these individuals all share the common interest of aircraft operation, advertisement of products which are attractive to people who travel often will be particularly effective with this group. The present invention specifically targets these consumers by placing the advertisement on an aviation checklist article, which is something that each pilot must specifically examine each time the aircraft is operated, and which has high personal value to each pilot.

In the field of aviation, printed checklists have been used extensively for many years in order to insure that aircraft operators follow standard procedures in operating the aircraft. The Federal Aviation Agency requires that all aircraft carry a complete checklist of items and functions to be performed by the pilot during various stages of flight. The checklist tends to be very complete including all mechanisms and systems that should be checked before the aircraft is started, during flight, and before and after landing. In recent years, computerized checklists have been used, although the most prevalent form of a checklist still tends to be a printed checklist normally consisting of a single card or booklet smaller than the size of a standard sheet of paper. Since the FAA requires a pilot to review and adhere to the checklist during each stage of the flight, the value of the checklist document is very high to the pilot. Furthermore, a checklist will vary according to the type of aircraft used, but the specific checklist with a specific airplane will remain consistent throughout the life of the plane. For this reason, it is reasonable to expect that a specific checklist will be retained by the pilot or owner inside the aircraft for twenty years or more.

### DESCRIPTION OF THE PRIOR ART

Although aviation checklists have been prevalent and required for decades, the articles have essentially remained unchanged in terms of delivery of the message, and none have previously incorporated an advertising message. In fact, the recent trend in aviation checklist and message delivery is toward computerization. U.S. Pat. No. 4,970,683 to Harshaw, et al. discloses a computerized checklist system which features predetermined sequences of sub-lists which are activated as needed. However, despite the widespread use of computerized databases and computerized aviation components generally, the printed checklist remains the dominant checklist article in the aviation industry as a result of its simplicity and versatility.

Looking outside the aviation checklist media, the prior art does feature a wide assortment of patents which utilize alternative methodology to selectively deliver an advertising message to a user of a specified product. For example, U.S. Pat. No. 6,041,532 to Pollhaus et al. features a number of articles of household use such as lighters, bottle openers and writing instruments which are reconfigured as advertisement delivery messengers. Specifically, when the article is used in its normal operation, a switch is activated which operates a sound reproduction device incorporated therein, such as a microcassette player, to deliver a pre-recorded advertising message.

U.S. Pat. No. 6,148,484 to Andreae, Jr, features a clip article to be used by golfers to hold the golf score card in an otherwise conventional golf cart. In addition to providing a holding mechanism for the score card, the clip serves to target deliver an advertising message to the users. (See FIG. 2) Likewise, U.S. Pat. No. 5,249,384 to Dark, Jr, discloses an apparatus and method for displaying an advertisement or other message inside a golf cup within a golf course.

Other unconventional advertisement delivery methods that direct target specific consumers during use include U.S. Pat. No. 5,415,541 to Stanton, as well as U.S. Pat. No. 5,373,653 to Suzuki, both of which claim variations of truck-mounted advertising systems. U.S. Pat. No. 5,642,484 to Harrison, III et al. features a “pump toy ” advertising display system for use at automated devices at point-of-sale locations, such as gasoline pumping stations. Adeseye claims a design for a combined lottery slip marking aid and advertisement display in Des. 413,932. Alternative advertising devices also appear in the prior art in conjunction with wall calendars, such as U.S. Pat. No. 6,138,391 to Ngan and Des. 391,991 to Conner.

### SUMMARY OF THE INVENTION

The aviation checklist article claimed in this patent is the first aviation checklist designed and constructed to serve as a medium to carry advertising to the pilot in the cockpit of an aircraft. As an aviation advertising medium, it is unique in that the pilot is a “captive market”-both in the sense that the article provides essential information that the pilot has purchased, and also because the pilot is literally “captive” in the physical confines of the cockpit. Accordingly, the primary objective of the present invention is to provide a direct access advertising article that will reach the pilot during the period of time in which he or she is operating the aircraft. Another key objective of the invention is to provide a reliable and effective methodology whereby an advertiser can target market goods or services to aircraft pilots and other aircraft personnel.

Another objective of this invention is to create an advertising article which is not only re-usable, but essential to the targeted consumer such that the article is retained for use over and over again. By attaching the advertising message to a repeat-use article which has high strategic value to the user, protection, retention and re-use of the article will be greatly enhanced. As a result, the life-expectancy of the advertising article will be extensive.

Another primary objective of the present invention is to provide an aviation checklist/advertising article apparatus that is easy to manufacture. In the preferred embodiment of this invention, the backside of each page of the checklist serves as the advertising backboard. As a result, the added cost of including the advertisement on an aviation checklist is nominal.

Yet another objective of this invention is to construct a targeted advertisement medium to flight personnel that will be sturdy and simple in construction. The present device achieves these purposes entirely.

As discussed above, the method of advertising and the aviation checklist of the present invention overcomes the disadvantages inherent in conventional advertising media aimed at aviation professionals in a targeted and effective manner. In this respect, before explaining at least one embodiment of the invention in detail, it is to be understood that the invention is not limited in its application to the details of construction and to the arrangements of the advertising flight list article set forth in following description or illustrated in the drawings. The invention is capable of other embodiments and of being practiced and carried out in various and diverse ways. Also, it is to be understood that the phraseology and terminology employed herein are for the purposes of description and should not be regarded as limiting.

Accordingly, those skilled in the art will appreciate that the concept upon which this invention is based may readily be utilized as a basis for the design of other structures, methods, and systems for carrying out the several purposes of the present invention. It is important, therefore, that the claims be regarded as including such equivalent constructions insofar as they do not depart from the spirit and scope of the present invention.

Furthermore, the purpose of the foregoing Abstract is to enable the U. S. Patent and Trademark Office and the public generally, and especially including the practitioners in the art who are not familiar with patent or legal terms or phraseology, to determine quickly from a cursory inspection, the nature and essence of the technical disclosure of the application. The Abstract is neither intended to define the invention of the application, nor is it intended to be limiting to the scope of the invention in any way.

### BRIEF DESCRIPTION OF THE DRAWINGS

Additional utility and features of this invention will become more fully apparent to those skilled in the art by reference to the following drawings, wherein the aviation checklist of the present invention is described more fully:

FIG. 1 is a front view of a spiral-bound aviation checklist shown in the open position whereby a sample advertisement is seen on the backside of the preceding page.

FIG. 2 is a side elevation view of an aviation checklist of the present invention.

FIG. 3 is a perspective view of a three-ring binder type aviation checklist shown in the open position, with the advertisement placement as indicated.

### DETAILED DESCRIPTION

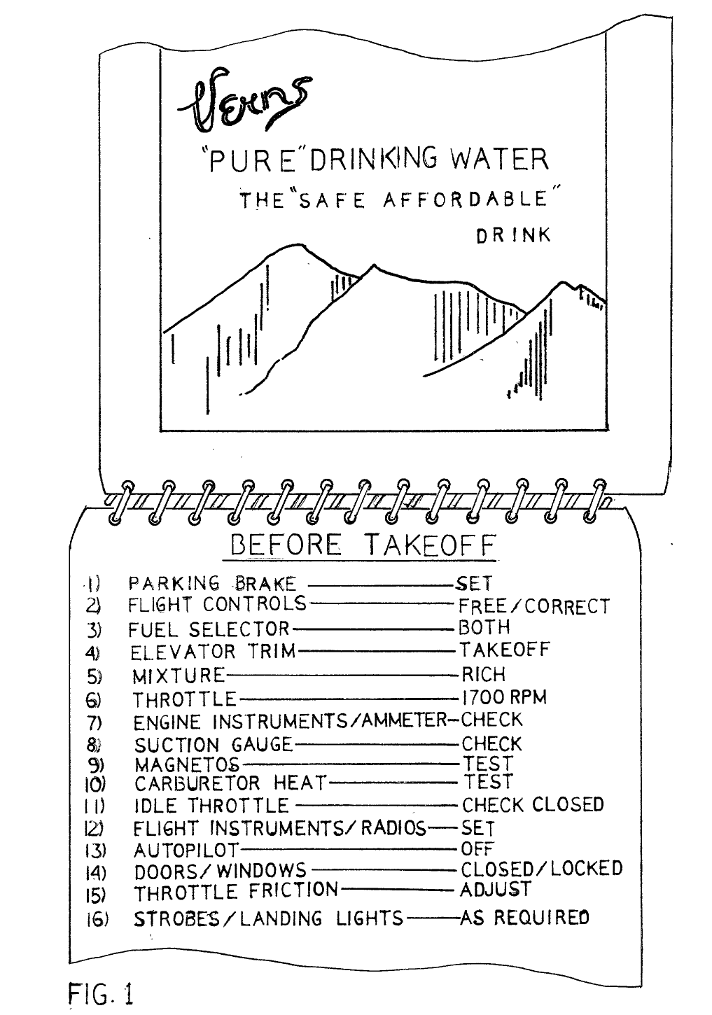

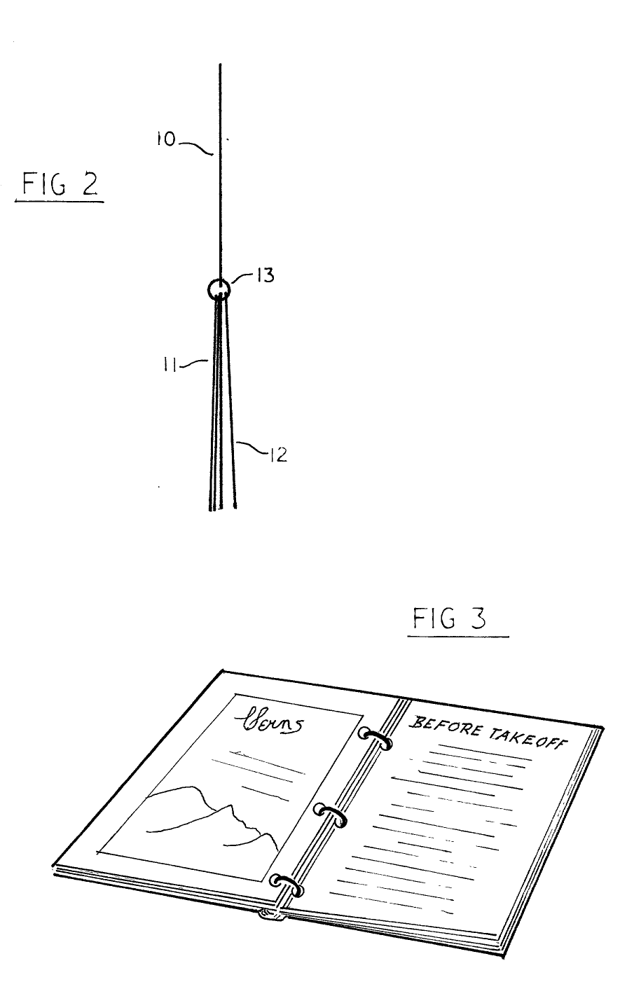

An aviation checklist of the present invention can take a variety of forms and constructions. A preferred aviation checklist article which incorporates an advertisement message can be found in FIG. 1 and FIG. 2, which show a spiral-bound or helical-coil bound checklist. Spiral binding is a very popular well-known conventional binding system, commonly used in situations in which the binding is meant to be permanent, without the need to add additional pages at a later date. The permanency and stability of a helical-coil binding also lends to the suitability of such a system for an aviation checklist.

As shown in FIG. 2, the checklist includes a first or front cover leaf 10 which defines a multiplicity of apertures along the top most binding edge, and a back cover 11 which also defines a multiplicity of apertures along the binding edge. The checklist is also characterized by an assortment of interior pages 12 which also feature the same multiplicity of apertures. The apertures along the binding edge of the aforementioned sheets are designed such as to line up with each other such as to receive a common binding element. The checklist features a helical-binding coil element 13 disposed along a coil axis, such that the turns of the coil element travel through the multiplicity of apertures of the checklist pages, thereby attaching the same in a spiral-bound notebook-type assembly. Most such coil elements are usually comprised of a single, continuous wire element such as that shown in U.S. Pat. No. 2,228,355 to Key. However, other configurations are also possible such as a “DuoWire” spiral binding offered by Akiles Products, Inc. of Ontario, Calif.

Another variation for binding of the checklist is a binding which features a tubular plastic member incorporating coaxial curled comb-like tine elements attached to a common elongated rib part. With this arrangement, the coaxial elements pass through respective slots (usually rectangular in shape) spaced along an edge of the sheets of paper. This type of binding is usually made of plastic and is generally known as a “plastic comb” binding, and is shown in U.S. Pat. No. 3,180,488 to Heusmann, which is incorporated herein by reference. As used hereafter, the term “spiral-binding” is intended to encompass either a wire helical binding or a plastic comb binding, both of which incorporate coaxial elements on a binding member.

With a spiral-bound mechanism, as one page of the article is turned, the back side of that page is exposed to the viewer and, accordingly, is an optimal location for an advertisement. As shown in FIG. 1, the advertisement would be placed on the back side of the aviation checklist pages for viewing by the pilot as the article is being used. The aviation checklist shown in FIG. 1 features a spiral binding located on the top edge of the sheets. Although not shown in the drawings, it is to be understood that other arrangements are also available such as a spiral binding located on the side “vertical” edge of the document, for somewhat of a traditional book format.

In addition to spiral binding, ring notebooks are also possible for use as an aviation checklist and the advertising method disclosed herein is also suitable for such medium. FIG. 3 is a perspective view of such arrangement. Ring notebooks hold individual pages, and are well known in the art, with optimal utility in situations in which it may be necessary or desirable to add or delete pages from the notebook. Although there are many variations of ring-based notebooks, the most common is a three-ring loose leaf notebook, with a spine for holding the rings along with a mechanism for opening and closing the rings. Ring notebook is defined herein as including any such similar notebook which may be opened and closed, which are generally circular but need not necessarily be so, and may employ other mechanisms for opening and closing the rings. For example, “D-style” ring mechanisms are also commercially available, and in wide-spread use.

An aviation checklist of this invention may also be produced utilizing conventional book binding means. These means could include adhesive binding, stitch binding, velobinding, thermal adhesives or any other conventional means.

Other embodiments are also within the scope of the claims of this invention. For example, while advertising panels may be located on the backsides of the checklist sheets as mentioned above, it also stands to reason that advertising panels may be locate on the sides or edges of the primary checklist sheets themselves. In addition, the front and/or back covers could also be used as locations for advertising panels. In addition to advertisement panels or logos, other direct sales overtures are possible such as fold-out advertisement panels and/or coupons.

I claim:

1. An aviation checklist to be used to verify and/or record information, including pre-flight, in-flight and pre-landing conditions and preparations characterized by:
a. A printed notebook body comprising a first and second cover pages and one or more interior pages containing said information, located between said first and second cover pages;
b. A binding means for binding together the cover pages and interior pages; and
c. One or more advertising panels located on one or more of said first and second cover pages and said interior pages, for communicating a message to the user of said aviation checklist.

2. An aviation checklist as described in claim 1, wherein said interior pages are constructed of one or more of a group of materials including; paper, laminated paper, or plastic.

3. The aviation checklist of claim 1 wherein said binding means is comprised of a helical binding coil element disposed along a coil axis, and wherein said first and second cover pages and said interior pages are further defined as including a multiplicity of binding apertures disposed along a binding edge of said pages with the spacing between said apertures corresponding to the spacing between the turns of said helical binding coil element.

4. The aviation checklist of claim 1 wherein said binding means is comprised of a tubular plastic member incorporating coaxial curled comb-like tine elements attached to a common elongated rib part, wherein said cover pages and interior pages are further defined as including a multiplicity of binding apertures, and wherein said tine elements pass through said apertures to bind the pages together to form a notebook.

5. The aviation checklist of claim 1 wherein said first, second and interior pages are further defined as including two or more generally round apertures, and wherein said binding means is further defined as a coaxial element of a binding member, within a notebook of the type having a spine and a plurality of spaced rings attached to the spine which may be opened and closed, and wherein said spaced rings generally match the spacing of said spaced apertures and generally correspond to conventional multi-ring notebooks.

6. The aviation checklist of claim 1 wherein said binding means is comprised of a conventional book binding means.

7. The aviation checklist of claim 1 wherein said advertising panels are located on the backside of said first or second covers or the backside of said interior pages.

8. The aviation checklist of claim 1 wherein said advertising panels are located on the front side and along the edges of said first and second covers or the front side along the edges of said interior pages.

9. A method for delivery of an advertising message to a user of an aviation checklist comprised of constructing an aviation checkbook characterized by:
a. A printed notebook body comprising a first and second cover pages and one or more interior pages containing said information, located between said first and second cover pages;
b. A binding means for binding together the cover pages and interior pages; and
c. One or more advertising panels located on one or more of said first and second cover pages and said interior pages, for communicating a message to the user of said aviation checklist.

10. The method of claim 9, wherein said interior pages of said aviation checkbook are constructed of one or more of a group of materials including; paper, laminated paper, or plastic.

11. The method of claim 9, wherein said binding means of said aviation checkbook is comprised of a helical binding coil element disposed along a coil axis, and wherein said first and second cover pages and said interior pages are further defined as including a multiplicity of binding apertures disposed along a binding edge of said pages with the spacing between said apertures corresponding to the spacing between the turns of said helical binding coil element.

12. The method of claim 9 wherein said binding means is comprised of a tubular plastic member incorporating coaxial curled comb-like tine elements attached to a common elongated rib part, wherein said cover pages and interior pages are further defined as including a multiplicity of binding apertures, and wherein said tine elements pass through said apertures to bind the pages together to form a notebook.

13. The method of claim 9 wherein said first, second and interior pages are further defined as including two or more generally round apertures, and wherein said binding means is further defined as a coaxial element of a binding member, within a notebook of the type having a spine and a plurality of spaced rings attached to the spine which may be opened and closed, and wherein said spaced rings generally match the spacing of said spaced apertures and generally correspond to conventional multi-ring notebooks.

14. The method of claim 9 wherein said binding means is comprised of a conventional book binding means.

15. The method of claim 9 wherein said advertising panels are located on the backside of said first or second covers or the backside of said interior pages.

16. The method of claim 9 wherein said advertising panels are located on the front side and along the edges of said first and second covers or the front side along the edges of said interior pages.
